(19) United States
(12) Patent Application Publication
(10) Pub. No.: US 2008/0056669 A1
(43) Pub. Date: Mar. 6, 2008

(54) AUDIO-VIDEO RECEIVING DEVICE WITH A BUILT-IN MEMORY

(76) Inventor: James Chu, Walnut, CA (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/468,827

(22) Filed: Aug. 31, 2006

(51) Int. Cl. H04N 5/91; H04N 7/00

(52) U.S. Cl. 386/83; 348/552

(57) ABSTRACT

An audio-video (AV) receiving device according to this invention, particularly the AV receiving device with the built-in memory, is disclosed, comprising an AV receiving device body in which a wireless receiver is provided to receive wireless AV signals; a video converter provided in the AV receiving device body to convert the received wireless AV signals to digital ones and transmit them to the computer for playback; and a memory module provided in the AV receiving device body to store the received wireless AV signals in the AV receiving device body instead of the computer, and to serve as a storage space for dada that is applied in a computer designed with the same specifications.

### FIELD OF THE INVENTION

This invention relates to an audio-video (AV) receiving device and particularly to that with a built-in memory.

### BACKGROUND OF THE INVENTION

Conventionally, a TV set is needed for watching TV programs, and a video receiving device provided in the TV set is used to receive and convert AV signals from the outside. In the future, almost all TV programs and telecasting AV signals will be transmitted wirelessly; thus, thanks to the change of times and the progressive technology, many people have computers at home and use them over a long period of time so as to use computer displays to watch TV and thus abandon the conventional TV sets that occupy spaces. With reference to FIG. 1 illustrating a conventional TV box 10 receiving TV programs, a computer display 12, and a computer 121 which communicating to work in a prior art; the TV box 10 comprises a power supply 14 supplying power by itself and an antenna 16, and through the antenna 16 of the TV box 10, external signals are received and transmitted to the computer 121 to process and convert and finally the video is shown on the computer display 12. However, there is a disadvantage in the prior art that TV programs that are wanted may be recorded in the computer 121 only, and thus it is inconvenient to record because users unlikely move the PC back and forth, which is not beneficial to space use.

In consideration of the mentioned-above defects of prior art, the AV receiving device with a built-in memory according to this invention is provided.

### SUMMARY OF THE INVENTION

It is an object of this invention to mainly provide an AV receiving device with a built-in memory, through which, favorite TV programs may be recorded in a memory built in the AV receiving device. The recorded TV programs may be watched, as long as the device is carried along with the user, which is very convenient.

It is the other object of this invention to mainly provide an AV receiving device with a built-in memory, which may be used to serve as a portable hard drive in which electronic documents may be temporarily stored, thereby the functional built-in memory being used effectively.

In order to achieve the object, the AV receiving device according to this invention, particularly the AV receiving device with the built-in memory, is disclosed, comprising an AV receiving device body in which a wireless receiver is provided to receive wireless AV signals; a video converter provided in the AV receiving device body to convert the received wireless AV signals to digital ones and transmit them to the computer for playback; and a memory module provided in the AV receiving device body to store the received wireless AV signals in the AV receiving device body instead of the computer, and to serve as a storage space for dada that is applied in a computer designed with the same specifications.

In order to further know the features and technical means of this invention, refer to the detailed description according to this invention accompanied with drawings; however, the accompanied drawings are provided for reference and illustration only and are not limited to this invention.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a view of a prior art; and

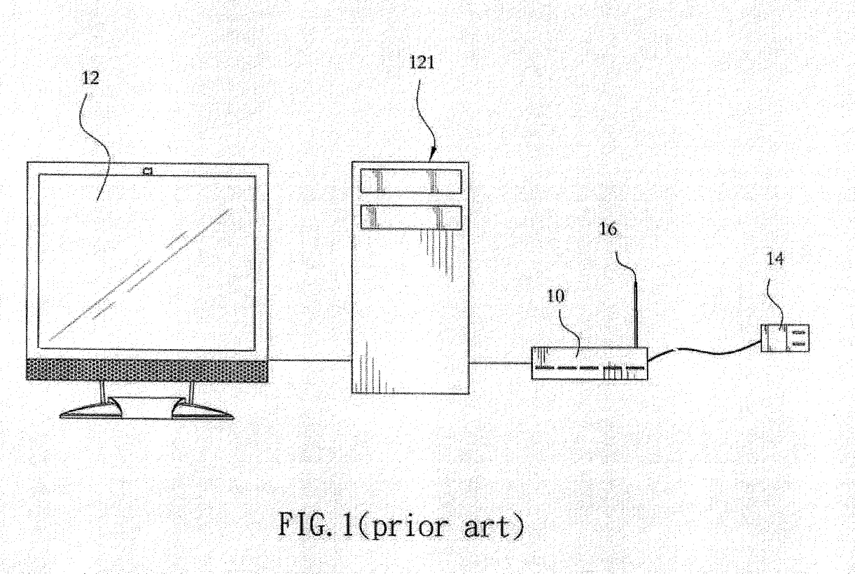

FIG. 2 is a view of an embodiment of an AV receiving device with a built-in memory according to this invention.

### DETAILED DESCRIPTION OF THE PREFERRED EMBODIMENTS

In order to let you further know the features and technical means of this invention, refer to the following detailed description according to this invention accompanied with drawings; however, the accompanied drawings are provided for reference and illustration only and are not limited to this invention.

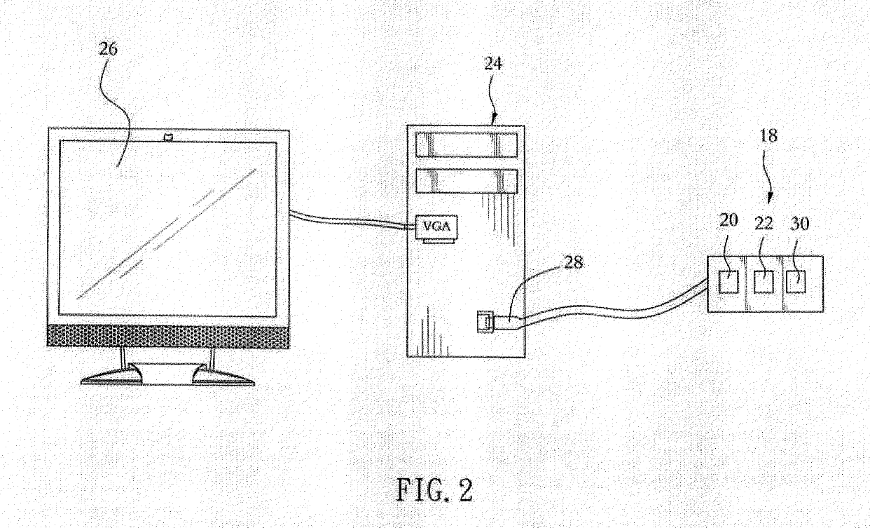

Refer to FIG. 2 as a view of an embodiment of an AV receiving device with a built-in memory according to this invention. As shown in the figure, an AV receiving device body 18 is provided, inside which a wireless receiver 20 is provided to receive wireless digital AV signals or wireless analog AV signals, in which the wireless signals may comprise DVB-T signals or ATSC signals. The AV receiving device body 18 may also be connected to a cable TV signal port to receive the cable TV signals, and through a video converter 22 in the AV receiving device body 18, the received wireless AV signals are converted to digital signals and then transmitted by a male connector 28 to a computer 24 for playback on a computer display 26, in which the male connector 28 may communicate with the computer 18 for data transmission and may be a high-speed USB serial interface or a high-speed 1394 serial interface. Especially, a memory module 30 is extra built in the AV receiving device body 18, in which the received wireless AV signals may be stored, or the memory module 30 may serve as a storage space for data from the computer 24, such as a portable flash drive, so that recorded AV programs may be portable and may be played back as long as the computer 24 is set, and the memory module 30 may also serve as a portable hard drive where electronic documents is temporarily stored, thereby the function of built-in memory being effectively used.

In order to achieve the object, the AV receiving device according to this invention, particularly the AV receiving device with the built-in memory, is disclosed, comprising an AV receiving device body in which a wireless receiver is provided to receive wireless AV signals; a video converter provided in the AV receiving device body to convert the received wireless AV signals to digital ones and transmit them to the computer for playback; and a memory module provided in the AV receiving device body to store the received wireless AV signals in the AV receiving device body instead of the computer, and to serve as a storage space for dada that is applied in a computer designed with the same specifications.

To sum up, from the disclosed art, this invention may provide a design widely different from the conventional design, which increases the entire use value, and further this invention is indeed unprecedented and has not been published and not similar to any other product in the market, so it completely meets the requirements of application for the patent. We earnestly request that this application be examined in detail and approved as soon as possible for protection of the inventor's rights and interests. Please feel free to contact us if you, the examiner, have any questions at the time of examination.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. An audio-video (AV) receiving device with a built-in memory, comprising an AV receiving device body in which a wireless receiver is provided to receive wireless AV signals;
a video converter provided in the AV receiving device body to convert the received wireless AV signals to digital ones and transmit them to the computer for playback; and
a memory module provided in the AV receiving device body to store the received wireless AV signals in the AV receiving device body or serve as a storage space for dada that is applied in the computer.

2. The audio-video receiving device with the built-in memory according to claim 1, wherein the wireless receiver receives digital AV signals or analog AV signals.

3. The audio-video receiving device with the built-in memory according to claim 1, wherein a male connector is provided in the AV receiving device body to communicate with the computer for data transmission.

4. The audio-video receiving device with the built-in memory according to claim 3, wherein the male connector is a high-speed USB serial interface.

5. The audio-video receiving device with the built-in memory according to claim 3, wherein the male connector is a high-speed 1394 serial interface.

6. The audio-video receiving device with the built-in memory according to claim 1, wherein the AV receiving device body is universal to be used in the computer designed with the same specifications.

7. The audio-video receiving device with the built-in memory according to claim 1, wherein the wireless signals are DVB-T signals.

8. The audio-video receiving device with the built-in memory according to claim 1, wherein the wireless signals are ATSC signals.
